(19) United States
(12) Patent Application Publication
(10) Pub. No.: US 2016/0373143 A1
(43) Pub. Date: Dec. 22, 2016

(54) WIRELESS DEVICE AND WIRELESS TRANSMISSION METHOD

(71) Applicant: FUJITSU LIMITED, Kawasaki-shi (JP)

(72) Inventors: Hikaru Ishikawa, Kawasaki (JP); Takashi Ono, Kawasaki (JP); KYOSUKE MUKAIDA, Kawasaki (JP)

(73) Assignee: FUJITSU LIMITED, Kawasaki-shi (JP)

(21) Appl. No.: 15/097,830

(22) Filed: Apr. 13, 2016

(30) Foreign Application Priority Data
Jun. 18, 2015 (JP) 2015-122773

(51) Int. Cl. H04B 1/04

(52) U.S. Cl. CPC H04B 1/0475; H04B 2001/0416

(57) ABSTRACT

A wireless device includes a clipping unit that compares a set threshold and power of a transmission signal, and suppresses power of the transmission signal when the power is equal to or higher than the threshold, an amplifier that amplifies the transmission signal, a memory that stores therein the threshold set in the clipping unit and a voltage value set in the amplifier, in association with an occupied bandwidth occupied by a plurality of carriers and a used bandwidth used as the carriers, and a processor that acquires carrier setting information indicating a carrier arrangement of a plurality of carriers included in the transmission signal, reads a threshold and a voltage value corresponding to an occupied bandwidth and a used bandwidth of the transmission signal from the memory, sets the read threshold in the clipping unit, and sets the read voltage value in the amplifier.

### CROSS-REFERENCE TO RELATED APPLICATION

This application is based upon and claims the benefit of priority of the prior Japanese Patent Application No. 2015-122773, filed on Jun. 18, 2015, the entire contents of which are incorporated herein by reference.

### FIELD

The embodiments discussed herein are related to a wireless device and a wireless transmission method.

### BACKGROUND

Generally, a wireless device in a digital wireless communication system is provided with an amplifier that amplifies power of a transmission signal. It is preferable that the amplifier linearly amplifies the power of the transmission signal. In particular, when a transmission signal with a large peak-to-average power ratio (PAPR) is to be amplified, input power to the amplifier may be increased, so that there is a need to linearly amplify the large input power.

However, a relationship between input power and output power of the amplifier becomes nonlinear with an increase in the input power, and a gain is gradually saturated. Therefore, when a transmission signal with a large PAPR is to be amplified, back-off of the amplifier may be increased by using a high-linearity amplifier or by increasing a drain voltage and a gate voltage of the amplifier. Furthermore, the PAPR of the transmission signal may be decreased by clipping the peak power through a peak suppression process called crest factor reduction (CFR) for example.

Patent Literature 1: Japanese Laid-open Patent Publication No. 2006-67073

Patent Literature 2: Japanese Laid-open Patent Publication No. 2001-244757

Incidentally, the peak power and the average power of a transmission signal vary depending on, for example, a modulation method, a carrier configuration, or the like. Therefore, the PAPR is not constant but always changing. Accordingly, in general, the back-off of the amplifier is increased or the peak suppression process is performed by setting a possible condition of maximizing the PAPR.

When the peak suppression process is performed, part of information of a transmission signal is lost due to clipping, so that modulation accuracy (Error Vector Magnitude (EVM)) is reduced. Therefore, the reduction of the PAPR by clipping is limited to a certain extent. In view of this, to increase the back-off of an amplifier, a high-linearity amplifier may be used or a drain voltage and a gate voltage of the amplifier may be increased.

However, the high-linearity amplifier is relatively expensive and cost may be increased. In contrast, when the drain voltage and the gate voltage of the amplifier are increased, power consumption is increased. Specifically, the amplifier is operated at a relatively large drain voltage and a relatively large gate voltage by setting a possible condition of maximizing the PAPR, so that even when an actual PAPR of a transmission signal is small, power consumption of the amplifier is always large. As a result, the amplifier wastes power, and power consumption of the wireless device increases.

### SUMMARY

According to an aspect of an embodiment, a wireless device includes: a clipping unit that compares a set threshold and power of a transmission signal, and suppresses power of the transmission signal when the power is equal to or higher than the threshold; an amplifier that amplifies the transmission signal whose power is suppressed by the clipping unit; a memory that stores therein the threshold set in the clipping unit and a voltage value set in the amplifier, in association with an occupied bandwidth occupied by a plurality of carriers and a used bandwidth used as the carriers in the occupied bandwidth; and a processor that acquires carrier setting information indicating a carrier arrangement of a plurality of carriers included in the transmission signal, reads a threshold and a voltage value corresponding to an occupied bandwidth and a used bandwidth of the transmission signal from the memory on the basis of the carrier setting information, sets the read threshold in the clipping unit, and sets the read voltage value in the amplifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a wireless communication system according to a first embodiment;

FIG. 2 is a block diagram illustrating a hardware configuration of an RE device according to the first embodiment;

FIG. 3 is a block diagram illustrating a configuration of an FPGA according to the first embodiment;

FIG. 4 is a block diagram illustrating a configuration of a clipping unit according to the first embodiment;

FIG. 5 is a flowchart illustrating a setting process according to the first embodiment;

FIG. 6 is a diagram for explaining an occupied bandwidth and a used bandwidth;

FIG. 7 is a diagram illustrating a specific example of a clipping threshold setting table;

FIG. 8 is a diagram illustrating a specific example of a voltage setting table;

FIG. 9 is a block diagram illustrating a configuration of an FPGA according to a modification of the first embodiment;

FIG. 10 is a block diagram illustrating a configuration of an FPGA according to a modification of the first embodiment;

FIG. 11 is a diagram illustrating a specific example of a voltage setting table according to a second embodiment; and

FIG. 12 is a diagram illustrating a specific example of an input-output characteristic of an amplifier.

### DESCRIPTION OF EMBODIMENTS

Preferred embodiments of the present invention will be explained with reference to accompanying drawings. The present invention is not limited by the embodiments below.

### [a] First Embodiment

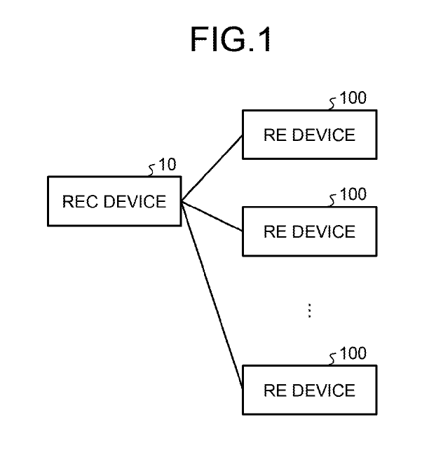

FIG. 1 is a block diagram illustrating a configuration of a wireless communication system according to a first embodiment. The wireless communication system illustrated in FIG. 1 includes a radio equipment control (REC) device 10 and radio equipment (RE) devices 100, which are connected to interfaces called a Common Public Radio Interface (CPRI). That is, a plurality of the RE devices 100 are connected to the REC device 10 via optical fibers. Incidentally, the configuration of the wireless communication system is not limited to the configuration as illustrated in FIG. 1, and other configurations, such as a configuration in which other RE devices are further connected to the respective RE devices 100 in FIG. 1, may be applied.

The REC device 10 performs baseband processing on transmission data and reception data. Specifically, the REC device 10 performs, for example, encoding and modulation on transmission data and generates a plurality of baseband signals corresponding to a plurality of carriers. Then, the REC device 10 transmits the generated baseband signals to the RE devices 100. Furthermore, the REC device 10 transmits, to the RE devices 100, carrier setting information indicating a carrier arrangement for transmitting each of the baseband signals, together with the baseband signals. The carrier setting information includes at least a center frequency and a bandwidth of each of carriers for transmitting the respective baseband signals.

The RE device 100 is connected to the REC device 10 via an optical fiber, and performs wireless processing on transmission data and reception data. Specifically, the RE device 100 performs digital-to-analog (DA) conversion and up-conversion on the baseband signals received from the REC device 10, and transmits an obtained wireless signal via an antenna. In this case, the RE device 100 transmits a signal, which is obtained by arranging the baseband signals to respective carriers at different frequencies in accordance with the carrier setting information.

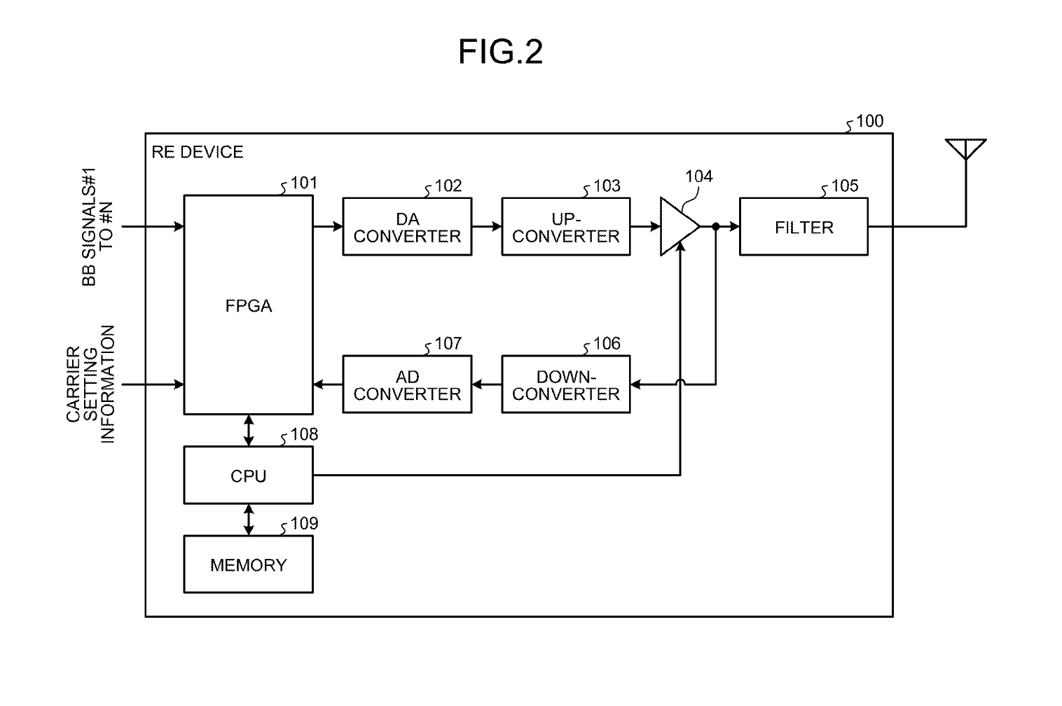

FIG. 2 is a block diagram illustrating a hardware configuration of the RE device 100 according to the first embodiment. The RE device 100 illustrated in FIG. 2 includes a field programmable gate array (FPGA) 101, a DA converter 102, an up-converter 103, an amplifier 104, a filter 105, a down-converter 106, an analog-to-digital (AD) converter 107, a central processing unit (CPU) 108, and a memory 109.

The FPGA 101 includes a CPRI interface, and receives a plurality of baseband signals (hereinafter, abbreviated as “BB signals”) #1 to #N (N is an integer equal to or greater than 2) and the carrier setting information that are transmitted from the REC device 10. Then, the FPGA 101 clips and arranges the BB signals #1 to #N to frequency bands corresponding to different carriers and performs distortion compensation based on a predistortion system, in accordance with settings in the CPU 108. The FPGA 101 outputs a predistortion signal obtained by the distortion compensation to the DA converter 102. The configuration of the FPGA 101 will be described in detail later.

The DA converter 102 performs DA conversion on the predistortion signal output from the FPGA 101, and outputs an obtained analog signal to the up-converter 103. The BB signals #1 to #N are respectively arranged in different frequency bands of the analog signal.

The up-converter 103 performs up-conversion on the analog signal output from the DA converter 102 to a radio frequency, and generates a wireless signal in which the BB signals ™1 to #N are arranged in different carriers. Then, the up-converter 103 outputs the generated wireless signal to the amplifier 104.

The amplifier 104 amplifies the wireless signal output from the up-converter 103. In this case, the amplifier 104 amplifies the wireless signal while consuming power corresponding to a gate voltage and a drain voltage set by the CPU 108. Then, the amplifier 104 outputs the amplified signal to the filter 105, and feeds the amplified signal as a feedback signal back to the down-converter 106.

The filter 105 attenuates a component outside the transmission band of the signal amplified by the amplifier 104, and wirelessly transmits an obtained transmission signal via the antenna.

The down-converter 106 performs down-conversion on the feedback signal fed back from the amplifier 104 to a baseband frequency. Then, the down-converter 106 outputs the feedback signal subjected to the down-conversion to the AD converter 107.

The AD converter 107 performs AD conversion on the feedback signal output from the down-converter 106, and outputs an obtained digital feedback signal to the FPGA 101. The feedback signal is used by the FPGA 101 to perform distortion compensation based on the predistortion system.

The CPU 108 acquires the carrier setting information received by the FPGA 101, and reads a clipping threshold, which corresponds to bandwidths of the carriers for transmitting the BB signals #1 to #N, and voltage setting in the amplifier 104 from the memory 109. That is, the CPU 108 acquires a clipping threshold that corresponds to an occupied bandwidth occupied by the carriers for transmitting the BB signals #1 to #N and that corresponds to a used bandwidth actually used as the carriers in the occupied bandwidth, and acquires a gate voltage and a drain voltage of the amplifier 104. Then, the CPU 108 sets the acquired clipping threshold in the FPGA 101, and sets the acquired gate voltage and the acquired drain voltage in the amplifier 104.

The memory 109 stores therein a clipping threshold setting table in which the clipping threshold in the FPGA 101 is stored in association with the occupied bandwidth and the used bandwidth, and a voltage setting table in which the gate voltage and the drain voltage of the amplifier 104 are stored in association with the occupied bandwidth and the used bandwidth.

Incidentally, the clipping threshold setting table stores a clipping threshold that increases with an increase in the occupied bandwidth. This is done in order to reduce information to be lost due to clipping and suppress degradation of EVM by increasing the clipping threshold for a large occupied bandwidth, because if the occupied bandwidth is increased due to a wideband of a signal, the peak power of the signal tends to increase. Furthermore, by reducing the clipping threshold for a small occupied bandwidth, it is possible to reduce power of a wireless signal input to the amplifier 104. Consequently, the amplifier 104 can linearly amplify a wireless signal even with relatively low power consumption, so that it becomes possible to reduce only nonlinear distortion.

Furthermore, the voltage setting table stores a gate voltage and a drain voltage that reduce power consumption of the amplifier 104 with a decrease in the occupied bandwidth and with an increase in the used bandwidth. Specifically, the voltage setting table stores a gate voltage and a drain voltage that reduce gate bias current and drain current of the amplifier 104 with a decrease in the occupied bandwidth and that reduce the gate bias current and the drain current of the amplifier 104 with an increase in the used bandwidth. The reason why the power consumption of the amplifier 104 is reduced with a decrease in the occupied bandwidth is that the amplifier 104 can linearly amplify a wireless signal even with relative low power consumption if the occupied bandwidth is small and a peak power is low. Furthermore, the reason why the power consumption of the amplifier 104 is reduced with an increase in the used bandwidth is that, under a condition in which power of a transmission signal transmitted from the antenna is constant, power per frequency is reduced with an increase in the used bandwidth, and power consumed by the amplifier 104 can remain low.

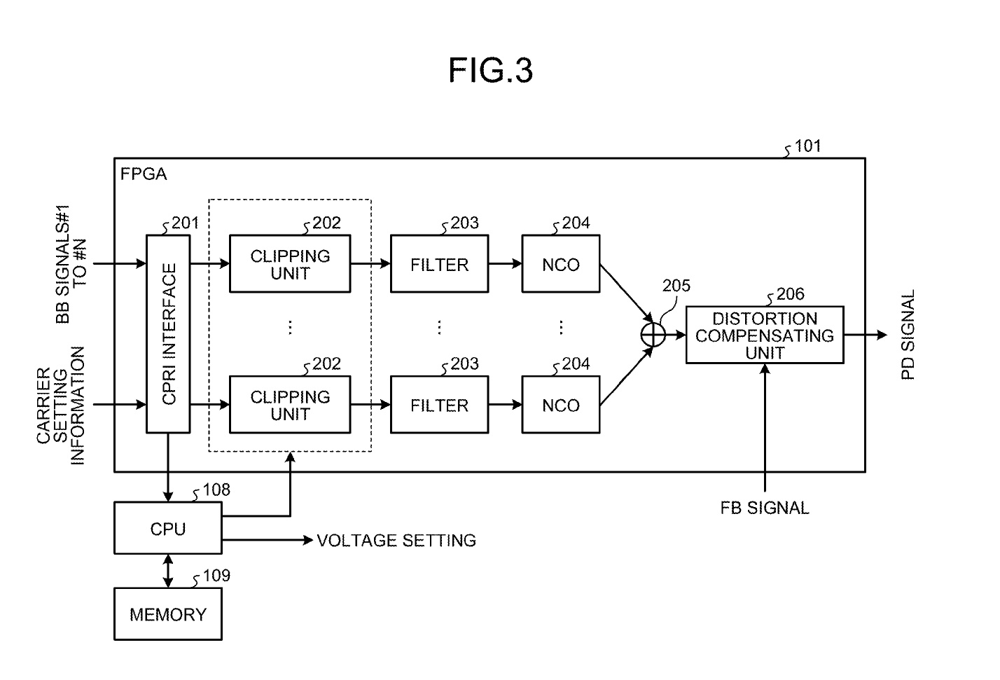

FIG. 3 is a block diagram illustrating a configuration of the FPGA 101 according to the first embodiment. The FPGA 101 illustrated in FIG. 3 includes a CPRI interface 201, clipping units 202, filters 203, numerically controlled oscillators (NCOs) 204, a synthesizing unit 205, and a distortion compensating unit 206. Among these units, the N clipping units 202, the N filters 203, and the N NCOs 204 are provided for the respective BB signals #1 to #N.

The CPRI interface 201 receives the BB signals #1 to #N and the carrier setting information from the REC device 10. Then, the CPRI interface 201 outputs the BB signals #1 to #N to the respective corresponding clipping units 202. Furthermore, the CPRI interface 201 outputs the carrier setting information to the CPU 108.

The clipping units 202 clip the respective input BB signals #1 to #N. Specifically, the clipping units 202 multiply the respective input BB signals #1 to #N by a suppression coefficient that suppresses power such that total power of the BB signals #1 to #N does not exceed the clipping threshold. As the suppression coefficient, for example, a ratio of the clipping threshold to power of each sample (clipping threshold/power of sample) may be used. Clipping performed by the clipping units 202 will be described in detail later.

The filters 203 attenuate unneeded band components that are generated in the respective BB signals #1 to #N due to clipping performed by the clipping units 202.

The NCOs 204 convert the frequencies of the respective input BB signals #1 to #N to frequency bands corresponding to the carriers for transmitting the respective BB signals. That is, the NCOs 204 convert the frequencies of the BB signals #1 to #N to mutually different frequency bands.

The synthesizing unit 205 synthesizes the BB signals #1 to #N subjected to the frequency conversion by the NCOs 204. In a synthesized signal output from the synthesizing unit 205, the BB signals #1 to #N are arranged in the frequency bands corresponding to the respective carriers.

The distortion compensating unit 206 performs distortion compensation on the synthesized signal output from the synthesizing unit 205 by using a feedback signal (hereinafter and in the drawings, abbreviated as an “FB signal”) output from the AD converter 107. Specifically, the distortion compensating unit 206 multiplies the synthesized signal by a distortion compensation coefficient that reduces an error between the synthesized signal and the FB signal corresponding to the synthesized signal. That is, the distortion compensating unit 206 gives, to the synthesized signal, a distortion with a characteristic opposite to the nonlinear distortion that has occurred in the amplifier 104, and outputs an obtained predistortion signal (in the drawings, abbreviated as a “PD signal”).

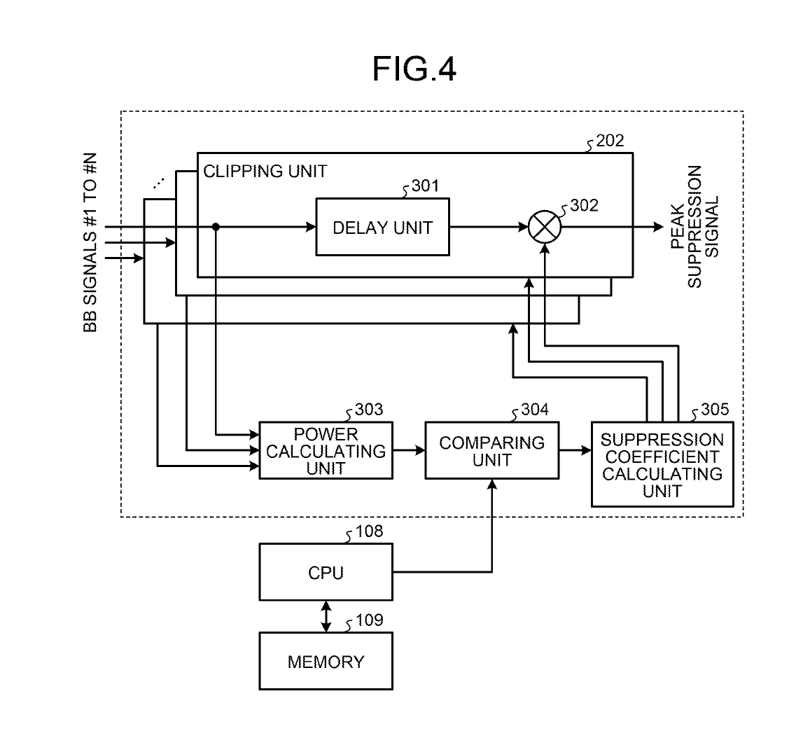

FIG. 4 is a block diagram illustrating a configuration of a clipping unit according to the first embodiment. In FIG. 4, a clipping unit including the clipping units 202 and peripheral circuits is illustrated. Specifically, the clipping unit illustrated in FIG. 4 includes, in addition to the N clipping units 202 corresponding to the BB signals #1 to #N, a power calculating unit 303, a comparing unit 304, and a suppression coefficient calculating unit 305. Furthermore, each of the clipping units 202 includes a delay unit 301 and a multiplying unit 302.

The delay unit 301 delays a sample of each of the input BB signals #1 to #N by a processing time taken by the power calculating unit 303, the comparing unit 304, and the suppression coefficient calculating unit 305.

The multiplying unit 302 multiplies the sample of each of the BB signals #1 to #N delayed by the delay unit 301 by the suppression coefficient calculated by the suppression coefficient calculating unit 305.

The power calculating unit 303 calculates total power of the samples of the BB signals #1 to #N input to the respective clipping units 202.

The comparing unit 304 compares the total power calculated by the power calculating unit 303 and the clipping threshold set by the CPU 108. Here, the clipping threshold set by the CPU 108 corresponds to the occupied bandwidth of the carriers for transmitting the BB signals #1 to #N. Therefore, the clipping threshold that increases with an increase in the occupied bandwidth of the carriers is set in the comparing unit 304. If the total power is greater than the clipping threshold as a result of the comparison, the comparing unit 304 notifies the suppression coefficient calculating unit 305 of the result.

The suppression coefficient calculating unit 305, when notified that the total power of the samples of the BB signals #1 to #N is greater than the clipping threshold by the comparing unit 304, calculates a suppression coefficient for suppressing power of each of the samples. Specifically, the suppression coefficient calculating unit 305 calculates a suppression coefficient for each of the samples such that the total power becomes equal to or smaller than the clipping threshold. Then, the suppression coefficient calculating unit 305 outputs the suppression coefficient calculated for each of the samples to the multiplying unit 302 of the corresponding clipping unit 202.

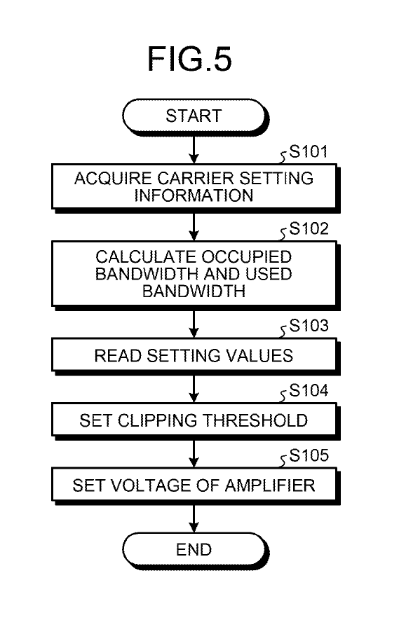

Next, with reference to a flowchart illustrated in FIG. 5, a process of setting the clipping threshold and a voltage of the amplifier 104 in the RE device 100 configured as above will be described with a specific example. FIG. 5 is a flowchart illustrating the setting process mainly performed by the CPU 108.

The BB signals #1 to #N and the carrier setting information transmitted from the REC device 10 are received by the CPRI interface 201 of the FPGA 101, and the BB signals #1 to #N are input to the respective corresponding clipping units 202. Furthermore, the CPU 108 acquires the carrier setting information (Step S101).

Upon acquiring the carrier setting information, the CPU 108 calculates an occupied bandwidth and a used bandwidth of carriers for transmitting the BB signals #1 to #N (Step S102). Specifically, the occupied bandwidth is calculated as a difference between the center frequency of a carrier at the lowest frequency and the center frequency of a carrier at the highest frequency. Furthermore, the used bandwidth is calculated as a total bandwidth of the bandwidths of all of the carriers.

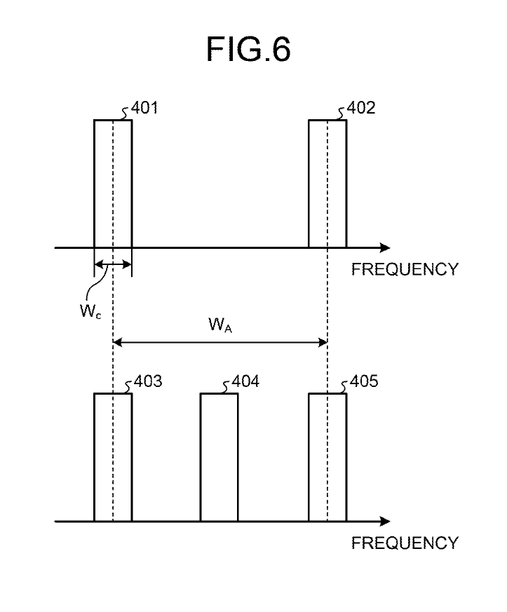

Specifically, in a carrier arrangement as illustrated in the upper part of FIG. 6 for example, a difference W_{A} between the center frequency of a carrier 401 at the lowest frequency and the center frequency of a carrier 402 at the highest frequency is calculated as the occupied bandwidth. Furthermore, in a carrier arrangement as illustrated in the lower part of FIG. 6 for example, a difference W_{A} between a carrier 403 at the lowest frequency and the center frequency of a carrier 405 at the highest frequency is calculated as the occupied bandwidth. The peak power of a signal depends on the occupied bandwidth, so that the signals in the carrier arrangements illustrated in the upper part and the lower part of FIG. 6 have approximately the same peak power even though the numbers of the carriers are different.

In contrast, if a bandwidth of each of the carriers 401 to 405 is denoted by W_{C}, a used bandwidth in the carrier arrangement illustrated in the upper part of FIG. 6 is calculated as 2W_{C} that is a total bandwidth of the two carriers 401 and 402. Furthermore, a used bandwidth in the carrier arrangement illustrated in the lower part of FIG. 6 is calculated as 3W_{C} that is a total bandwidth of the three carriers 403 to 405. In this manner, even when the occupied bandwidths are the same, the used bandwidths may be different depending on the carrier arrangements indicated by the carrier setting information. In the first embodiment, the clipping threshold and the voltage of the amplifier 104 are not set for each of a number of carrier arrangements, but are set by focusing on the occupied bandwidth and the used bandwidth. Therefore, it is possible to efficiently set the clipping threshold and the voltage of the amplifier 104 by a simple process using a small number of parameters.

If the occupied bandwidth and the used bandwidth as described above are calculated, the CPU 108 refers to the memory 109, and reads setting values of the clipping threshold and the voltage of the amplifier 104 corresponding to the occupied bandwidth and the used bandwidth (Step S103). Specifically, the CPU 108 reads the clipping threshold from the clipping threshold setting table stored in the memory 109, and reads the gate voltage and the drain voltage of the amplifier 104 from the voltage setting table.

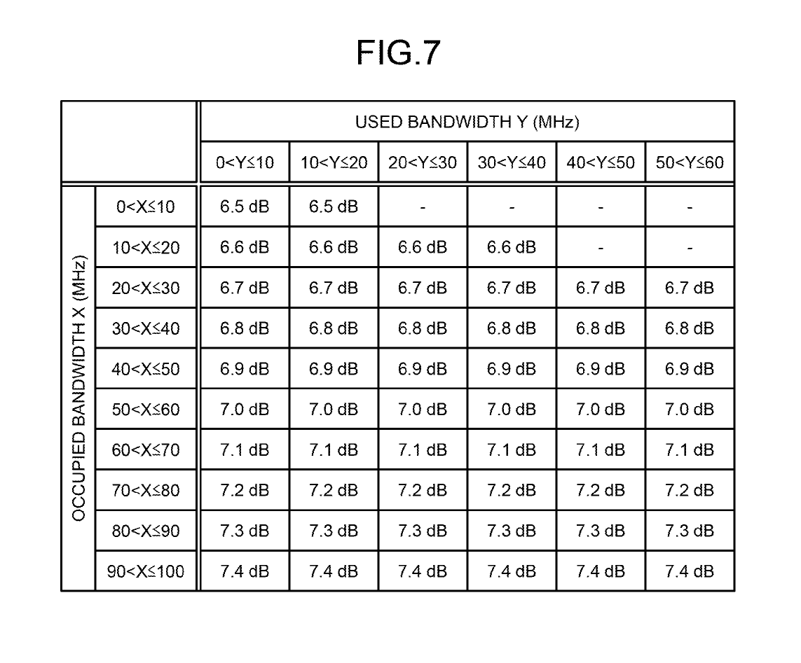

FIG. 7 is a diagram illustrating a specific example of the clipping threshold setting table. As illustrated in FIG. 7, the clipping threshold setting table stores a greater clipping threshold for a greater occupied bandwidth. For example, the clipping threshold is 6.5 dB for the occupied bandwidth of 0 MHz to 10 MHz, and the clipping threshold is 7.4 dB for the occupied bandwidth of 90 MHz to 100 MHz. Therefore, the clipping threshold is increased for a signal with a greater occupied bandwidth and greater peak power, so that it is possible to reduce an amount of information to be lost due to clipping and suppress degradation of EVM. In contrast, a smaller clipping threshold is set for a signal with a smaller occupied bandwidth and smaller peak power, so that power of the clipped signal is reduced. Consequently, power of a wireless signal input to the amplifier 104 is reduced, and a predetermined distortion characteristic can be obtained without increasing the power consumption of the amplifier 104.

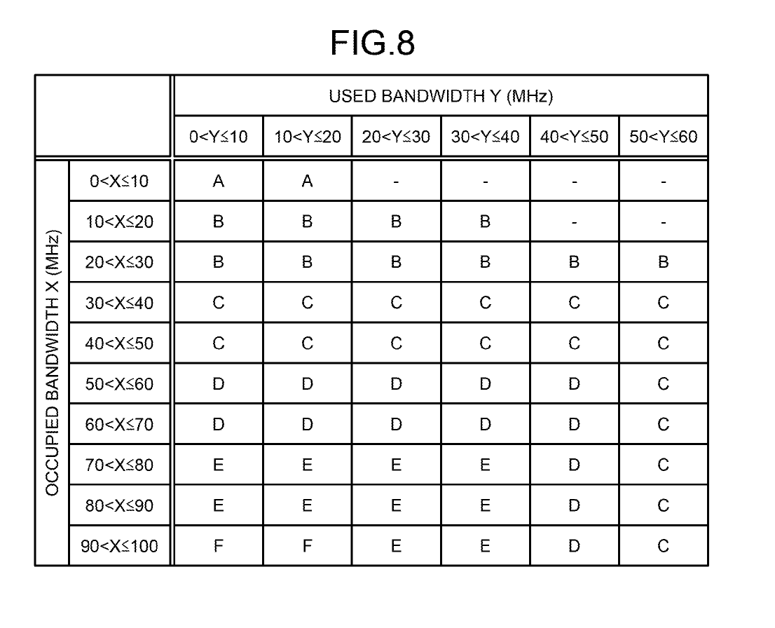

FIG. 8 is a diagram illustrating a specific example of the voltage setting table. In FIG. 8, the power consumption of the amplifier 104 increases with voltage values A, B, C, D, E, and F in this order. In other words, the power consumption of the amplifier 104 is the smallest at the voltage value A, and the power consumption of the amplifier 104 is the greatest at the voltage value F. As illustrated in FIG. 8, the voltage setting table stores a voltage value that reduces the power consumption of the amplifier 104 with a decrease in the occupied bandwidth and that reduces the power consumption of the amplifier 104 with an increase in the used bandwidth if the occupied bandwidth is the same. Incidentally, the voltage setting table illustrated in FIG. 8 is a table related to one of the gate voltage and the drain voltage of the amplifier 104, and the memory 109 may store therein two voltage setting tables respectively corresponding to the gate voltage and the drain voltage.

As described above, the voltage setting table stores a voltage value that reduces the power consumption of the amplifier 104 with a decrease in the occupied bandwidth. Therefore, if the occupied bandwidth is small and the peak power is low, it is possible to reduce the power consumption of the amplifier 104. Furthermore, the voltage setting table stores a voltage value that reduces the power consumption of the amplifier 104 with an increase in the used bandwidth. Therefore, if power needed to amplify each frequency is low, it is possible to reduce the power consumption of the amplifier 104. That is, if an adequate distortion characteristic can be obtained even when the power consumption of the amplifier 104 is reduced, it is possible to set, in the amplifier 104, a voltage value that reduces the power consumption.

Referring back to FIG. 5, if the clipping threshold and the voltage setting of the amplifier 104 are read, the CPU 108 sets the clipping threshold in the clipping unit of the FPGA 101 (Step S104). Specifically, the clipping threshold, which is to be compared with the total power of the samples of the BB signals #1 to #N calculated by the power calculating unit 303, is set in the comparing unit 304. When the clipping threshold is set as described above, and if the total power exceeds the clipping threshold, clipping is performed by multiplying each of the samples by a suppression coefficient that adjusts the total power to be equal to or lower than the clipping threshold.

Furthermore, the CPU 108 sets the voltage of the amplifier 104 (Step S105). In this setting, it may be possible to set both of the gate voltage and the drain voltage of the amplifier 104, or one of the gate voltage and the drain voltage. The voltage of the amplifier 104 is set to a voltage value corresponding to the occupied bandwidth and the used bandwidth, so that the amplifier 104 does not waste power, and it is possible to suppress an increase in the power consumption of the RE device 100.

As described above, according to the first embodiment, the occupied bandwidth and the used bandwidth of the carriers for transmitting the baseband signals are calculated based on the carrier setting information, and the clipping threshold and the voltage of the amplifier corresponding to the occupied bandwidth and the used bandwidth are set. Therefore, it is possible to appropriately adjust the power consumption of the amplifier in accordance with a carrier arrangement of a transmission signal, enabling to suppress an increase in the power consumption.

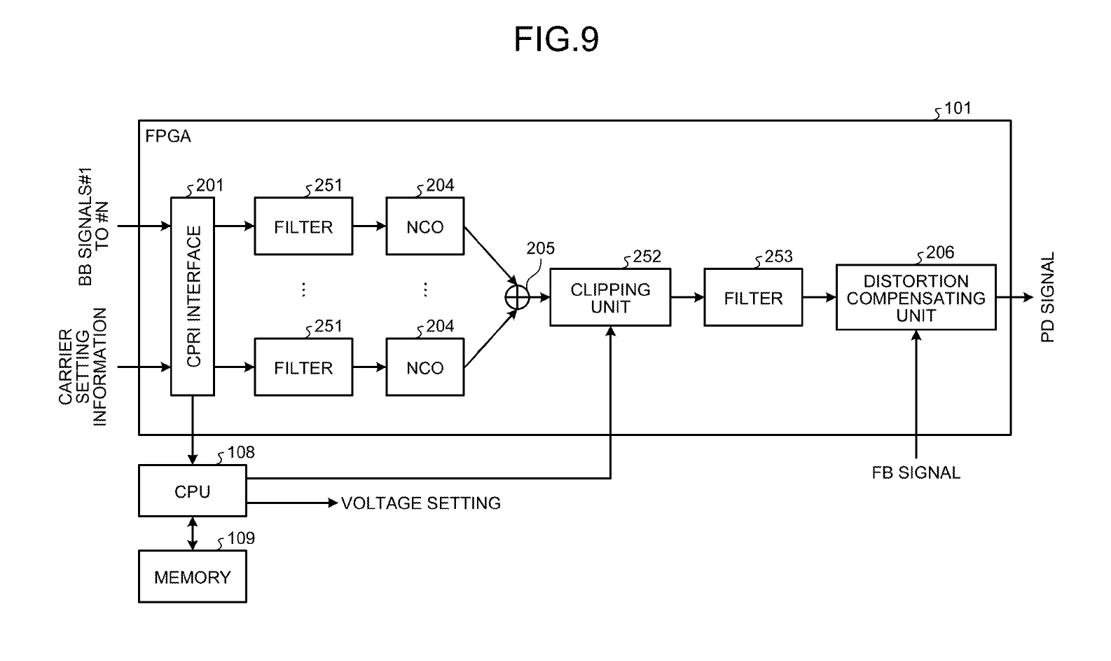

Incidentally, while each of the BB signals #1 to #N is clipped in the above-described first embodiment, it may be possible to clip the synthesized signal obtained by synthesizing the BB signals #1 to #N. FIG. 9 is a block diagram illustrating a configuration of the FPGA 101 for clipping the synthesized signal. In FIG. 9, the same components as those illustrated in FIG. 3 are denoted by the same signs, and explanation thereof will be omitted. The FPGA 101 illustrated in FIG. 9 includes filters 251, a clipping unit 252, and a filter 253, instead of the clipping units 202 and the filters 203 of the FPGA 101 illustrated in FIG. 3. Among these units, the N filters 251 are provided for the respective BB signals #1 to #N.

The filters 251 attenuates unneeded band components in the respective BB signals #1 to #N received by the CPRI interface 201.

The clipping unit 252 clips the synthesized signal output from the synthesizing unit 205. Specifically, the clipping unit 252 multiplies the synthesized signal by a suppression coefficient such that power of the synthesized signal does not exceed the clipping threshold. In this case, the clipping unit 252 compares the clipping threshold set by the CPU 108 and power of a sample of the synthesized signal, and multiples a sample having greater power than the clipping threshold by the suppression coefficient. As the suppression coefficient, for example, a ratio of the clipping threshold to power of each sample (clipping threshold/power of sample) may be used.

The filter 253 attenuates an unneeded band component that is generated in the synthesized signal due to clipping performed by the clipping unit 252.

As described above, when the synthesized signal is clipped, the CPU 108 sets the clipping threshold corresponding to the occupied bandwidth in the clipping unit 252. Therefore, it is possible to reduce the clipping threshold for a signal with a small occupied bandwidth and low peak power, enabling to reduce power of a wireless signal input to the amplifier 104. Consequently, it is possible to obtain a predetermined distortion characteristic without increasing the power consumption of the amplifier 104.

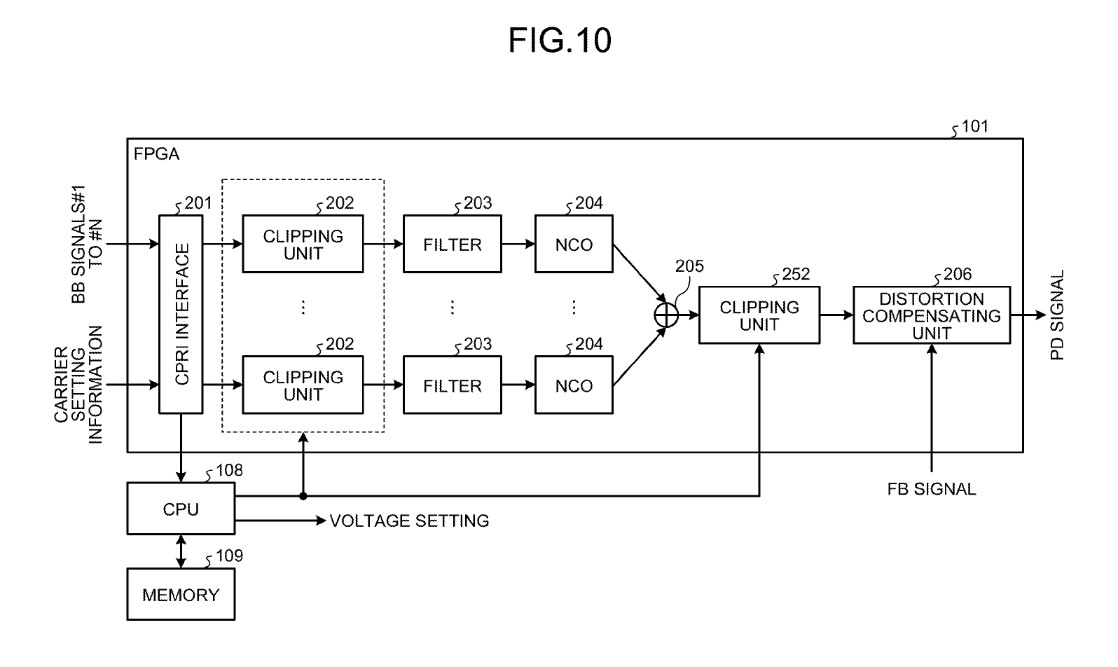

Furthermore, it may be possible to clip the BB signals #1 to #N and clip the synthesized signal. FIG. 10 is a block diagram illustrating a configuration of the FPGA 101 for clipping both of the BB signals #1 to #N and the synthesized signal. In FIG. 10, the same components as those illustrated in FIGS. 3 and 9 are denoted by the same signs, and explanation thereof will be omitted. The FPGA 101 illustrated in FIG. 10 has a configuration in which the clipping unit 252 illustrated in FIG. 9 is added to the FPGA 101 illustrated in FIG. 3.

The reason why this configuration is employed will be described below. That is, if the clipping units 202 clip the respective BB signals #1 to #N, the total power of the BB signals #1 to #N becomes equal to or lower than the clipping threshold. However, when the BB signals #1 to #N subsequently pass through the filters 203, waveforms of the BB signals #1 to #N are changed and the total power of the BB signals #1 to #N may become higher than the clipping threshold. Therefore, in the configuration illustrated in FIG. 10, after the synthesizing unit 205 synthesizes the BB signals #1 to #N, the clipping unit 252 clips the synthesized signal. In this configuration, power of the synthesized signal certainly becomes equal to or lower than the clipping threshold, so that it is possible to reduce power of a wireless signal input to the amplifier 104. Incidentally, in the configuration illustrated in FIG. 10, power suppressed by the clipping unit 252 is relatively low, and therefore, a filter is not provided in the stage subsequent to the clipping unit 252.

### [b] Second Embodiment

A characteristic of a second embodiment is in that a gate voltage and a drain voltage of an amplifier are set to constant, and a distortion characteristic is improved by changing a clipping threshold while fixing power consumption of an amplifier.

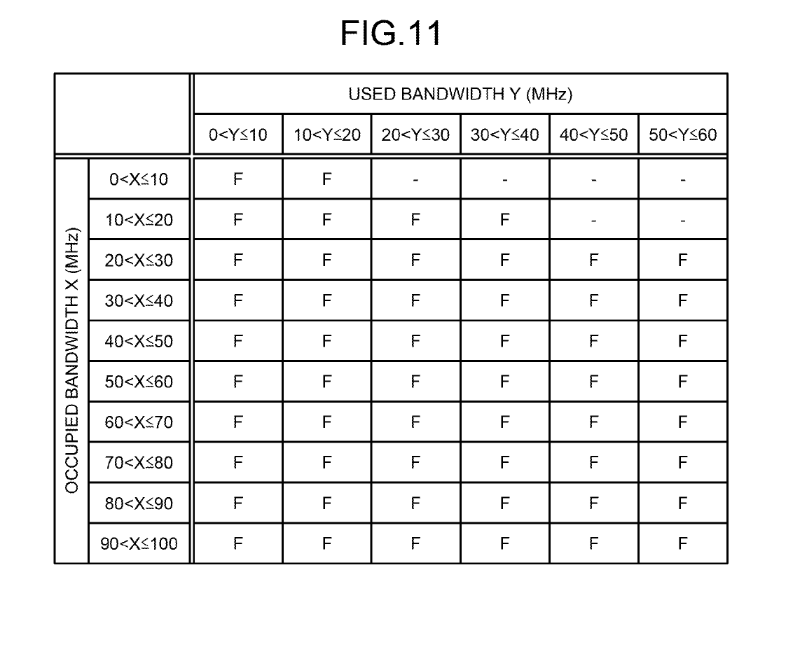

The configurations of a wireless communication system and RE devices according to the second embodiment are the same as those of the first embodiment (FIGS. 1 to 4), and therefore, explanation thereof will be omitted. The memory included in the RE device of the second embodiment stores therein, similarly to the first embodiment, the clipping threshold setting table and the voltage setting table. Of these tables, the clipping threshold setting table stores a greater clipping threshold for a greater occupied bandwidth, similarly to the first embodiment. In contrast, as illustrated in FIG. 11, the voltage setting table stores, for example, a constant voltage value F in association with all of the occupied bandwidths and the used bandwidths. That is, in the second embodiment, the fixed voltage value F is stored in association with the occupied bandwidths and the used bandwidths. The voltage value F corresponds to the voltage value F illustrated in FIG. 8, and corresponds to the gate voltage and the drain voltage of the amplifier, by which the minimum distortion characteristic can be obtained even under the worst condition in which the occupied bandwidth is large and the used bandwidth is small.

In the second embodiment, the voltage of the amplifier is constant, whereas the clipping threshold corresponding to the occupied bandwidth is set based on the carrier setting information. Therefore, a signal with a large occupied bandwidth and high peak power is clipped by using a relatively large clipping threshold, and a signal with a small occupied bandwidth and low peak power is clipped by using a relatively small clipping threshold. In this case, as a suppression coefficient for the clipping, for example, a ratio of the clipping threshold to power of each sample (clipping threshold/power of sample) may be used. As a result of clipping corresponding to the occupied bandwidth, as for a signal with low peak power, it is possible to reduce power of a wireless signal input to the amplifier while maintaining the EVM constant. Therefore, the wireless signal is more linearly amplified and the distortion characteristic can be improved.

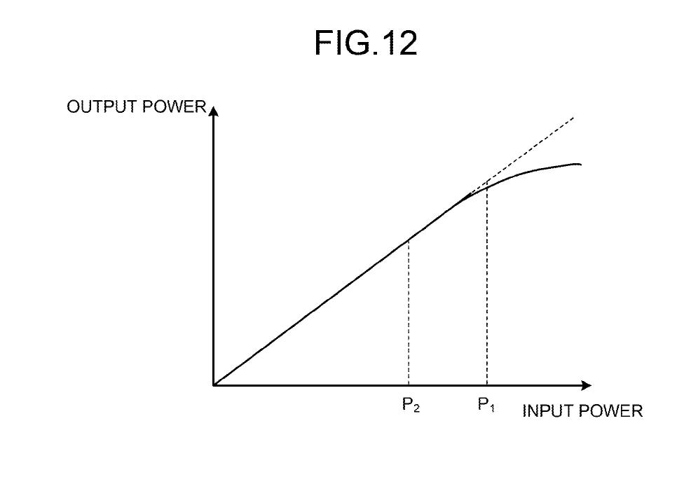

As a specific example, as illustrated in FIG. 12, the amplifier has an input-output characteristic such that a wireless signal is linearly amplified in a range in which the input power and the output power are relatively low, whereas a wireless signal is non-linearly amplified in a range in which the input power and the output power are relatively high. Therefore, if the peak power is high and the clipping threshold is large, power of a wireless signal input to the amplifier reaches P₁ for example, and the wireless signal is non-linearly amplified. Consequently, nonlinear distortion occurs in the amplifier, and a preferable distortion characteristic is not obtained.

In contrast, if the clipping threshold corresponding to the occupied bandwidth is set, it is possible to set power of a wireless signal input to the amplifier to, for example, P₂ when the clipping threshold is small, so that it becomes possible to linearly amplify the wireless signal. Consequently, it becomes possible to improve the distortion characteristic as compared to the case where the power of the wireless signal is P₁.

As described above, according to the second embodiment, the voltage of the amplifier is fixed, and the clipping threshold corresponding to the occupied bandwidth is set. Therefore, a signal with a small occupied bandwidth and low peak power is clipped by using a relatively small clipping threshold, so that it is possible to reduce power of a wireless signal input to the amplifier. Consequently, it is possible to improve the distortion characteristic without increasing the power consumption of the amplifier.

Incidentally, in the above-described embodiments, the wireless communication system including the REC device 10 and the RE devices 100 connected by the CPRI interfaces has been described as an example; however, the present invention may be applied to other wireless communication systems. That is, the present invention is applicable to a wireless device that transmits signals by using a plurality of carriers and that is used in a wireless communication system in which a carrier arrangement is changed.

According to an embodiment of the wireless device and the wireless transmission method disclosed herein, it is possible to suppress an increase in power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless device comprising:
a clipping unit that compares a set threshold and power of a transmission signal, and suppresses power of the transmission signal when the power is equal to or higher than the threshold;
an amplifier that amplifies the transmission signal whose power is suppressed by the clipping unit;
a memory that stores therein the threshold set in the clipping unit and a voltage value set in the amplifier, in association with an occupied bandwidth occupied by a plurality of carriers and a used bandwidth used as the carriers in the occupied bandwidth; and
a processor that acquires carrier setting information indicating a carrier arrangement of a plurality of carriers included in the transmission signal, reads a threshold and a voltage value corresponding to an occupied bandwidth and a used bandwidth of the transmission signal from the memory on the basis of the carrier setting information, sets the read threshold in the clipping unit, and sets the read voltage value in the amplifier.

2. The wireless device according to claim 1, wherein the memory stores therein a threshold setting table for storing a threshold that increases with an increase in the occupied bandwidth.

3. The wireless device according to claim 1, wherein the memory stores therein a voltage setting table for storing a voltage value that reduces power consumption of the amplifier with a decrease in the occupied bandwidth.

4. The wireless device according to claim 1, wherein the memory stores therein a voltage setting table for storing a voltage value that reduces power consumption of the amplifier with an increase in the used bandwidth.

5. The wireless device according to claim 1, wherein the memory stores therein a voltage value indicating a gate voltage or a drain voltage of the amplifier.

6. The wireless device according to claim 2, wherein the memory stores therein a voltage setting table for storing a fixed voltage value in association with the occupied bandwidth and the used bandwidth.

7. The wireless device according to claim 1, wherein the processor calculates, as the occupied bandwidth, a difference between a center frequency of a carrier at a lowest frequency and a center frequency of a carrier at a highest frequency on the basis of the carrier setting information.

8. The wireless device according to claim 1, wherein the processor calculates, as the used bandwidth, a total of bandwidths of all of the carriers on the basis of the carrier setting information.

9. A wireless transmission method implemented by a wireless device that includes a clipping unit that compares a set threshold and power of a transmission signal, and suppresses power of the transmission signal when the power is equal to or higher than the threshold, and an amplifier that amplifies the transmission signal whose power is suppressed by the clipping unit, the wireless transmission method comprising:
acquiring carrier setting information indicating a carrier arrangement of a plurality of carriers included in the transmission signal;
reading, from a memory that stores therein the threshold set in the clipping unit and a voltage value set in the amplifier, in association with an occupied bandwidth occupied by the carriers and a used bandwidth used as the carriers in the occupied bandwidth, a threshold and a voltage value corresponding to an occupied bandwidth and a used bandwidth of the transmission signal from the memory on the basis of the carrier setting information;
setting the read threshold in the clipping unit; and
setting the read voltage value in the amplifier.
